(19) United States
(12) Patent Application Publication
(10) Pub. No.: US 2016/0302629 A1
(43) Pub. Date: Oct. 20, 2016

(54) BODY DRIER FOR SHOWER OR BATH

(71) Applicant: LIFEAK JOB ACCOMMODATION SOLUTIONS FOR LIFE, S.L., Pamplona (Navarra) (ES)

(72) Inventors: Alvaro CASLA ARRUIZ, Pamplona (Navarra) (ES); Ion ESANDI MATEO, Pamplona (Navarra) (ES); Patxi FABO OLLOBARREN, Pamplona (Navarra) (ES); Julen VALGANON PETRIZAN, Pamplona (Navarra) (ES); Carmelo PUYO IRISARRI, Pamplona (Navarra) (ES); Joaquin SEVILLA MORODER, Pamplona (Navarra) (ES); Jose Ramon ALFARO LOPEZ, Pamplona (Navarra) (ES)

(21) Appl. No.: 15/102,644

(22) PCT Filed: Dec. 10, 2014
(86) PCT No.: PCT/ES2014/070903

§ 371 Date: Jun. 8, 2016

(30) Foreign Application Priority Data
Dec. 11, 2013 (ES) 201331811

(51) Int. Cl. A47K 10/48; F26B 21/00; A47K 3/28

(52) U.S. Cl. CPC A47K 10/48; A47K 3/281; F26B 21/004

(57) ABSTRACT

The invention relates to a body drier for a shower or bath, formed by a column which longitudinally defines a channel (6) on the inside thereof, said channel becoming progressively narrower from the upper part to the lower part, with a distribution of diffusion openings (7) for the outflow of air on the front part and an opening (8) on the upper part, in relation to which a mouth element (9) is arranged, to which the air outlet of a fan (10) is coupled.

### FIELD OF THE ART

The present invention relates to personal hygiene and particularly to drying after a shower or bath, proposing an apparatus that allows performing integral drying of the entire body under advantageous conditions and with enormous effectiveness.

### STATE OF THE ART

For drying the body after a shower or bath, the most common practice is to use towels, which is rather laborious for achieving effective, integral drying of the entire body, requiring towels to that end which, for hygienic reasons, must be used by a single person, which normally entails needing multiple towels in homes and a very large number of towels in public places such as hotels, hospitals, etc.

This involves a considerable cost for having the necessary towels available both in private homes and in public places, with an also important cost in terms of products and energy expenditure of machines for the frequent washing required to keep the towels in hygienic conditions, in addition to the time needed and the time spent by people required for that function.

In addition, the use of towels is often times complicated, even impossible, for people with disabilities, the intervention of other people who can help with using towels to dry off those people who must be dried being necessary in such cases.

Drier apparatus have been developed to solve those problems, which apparatus allow, by means of the projection of air, generally with temperature regulation, performing the drying function without having to use towels, thereby eliminating the drawbacks thereof. An apparatus of this type is, for example, the one disclosed in Spanish utility model ES 1070751U, formed by a hollow column provided with a distribution of diffusers for the outflow of air, having a fan driving a projection of air into said column, through a heating resistor, so that the air is projected out through the diffusers of the column. Said utility model contemplates shapes of the column of the drier apparatus that allow the projection of air through the diffusers in order to strike the body of a person of average height and to strike the person's head, but does not provide an effective projection of air to the foot area, so in order to complete integral drying, users have to lift their feet up, adopting uncomfortable postures and posing a risk of falling.

This problem of drying feet is exacerbated when users have disabilities, because it is extremely difficult or impossible for them to adopt the postures needed to adequately dry their feet, thereby also increasing the risk of falling.

In addition, in order to achieve optimal drying effectiveness by means of projecting air, the drier apparatus must comply with structural conditions favoring circulation of the air in order for it to uniformly flow out through the diffusers of the column and at a pressure suitable for drying, but which is not uncomfortable for the user, and these are features that the drier apparatus existing today do not comply in the manner deemed optimal.

### OBJECT OF THE INVENTION

The present invention proposes a body drier apparatus which is applied for people to dry off after taking a shower or bath, having features that allow integral drying of the entire body under advantageous conditions of effectiveness and performance.

This apparatus object of the invention consists of a column which is about the average height of a person, longitudinally defining a channel on the inside thereof, which channel is closed along the side edges and at the upper and lower ends of the column and from which a distribution of openings defined with an outwardly protruding edge are open on the front part of the column; whereas on the upper part of the column an opening is defined in relation to which a mouth element is arranged, to which the fan for driving air is coupled.

An apparatus in which the fan arranged on the upper part drives an airflow that enters the column and circulates through the inside thereof in order to flow out through the openings of the front part acting as diffusers for projecting the air to the outside is thereby obtained, such that the air flowing out through said diffusion openings allows drying a user who is in front of the column of the apparatus.

The mouth element that is arranged between the fan for driving the air and the inlet opening for flowing into the column has a configuration defining an inflow of the air into the column that is virtually aligned with the inner channel thereof, which prevents head loss of the air in said inflow, taking optimal advantage of the action of the fan driving the air.

Said mouth element through which the air passes from the fan into the column has a ratio between the inlet part through which air is received from the fan and the outlet part through which air enters the column, defining the passage of air under conditions that allow being able to achieve the necessary drive of the air into the column with a lower energy expenditure of the fan for optimal functional effectiveness of the drier.

Furthermore, the inner channel of the column through which air circulates to flow out through the diffusion openings for projecting the air outwards becomes progressively narrower from top to bottom, thereby defining a compensation for the loss of speed in the circulation of the air due to the flow rate dropping as a result of the gradual outflow of air through the diffusion openings from the upper part to the lower part of the column, a uniform outflow of air through all the diffusion openings thereby being achieved.

In addition, the outwardly protruding edge of the diffusion openings is envisaged, where appropriate, according to a curved taper, with a radius of curvature and a ratio between the end aperture and the base aperture, which favors the outflow of air without any head loss, which also makes it easier to take advantage of the speed of the air circulating through the inside of the column, optimizing the functional behavior of the drier.

Additionally, in its longitudinal configuration the column is envisaged to be formed by a vertical middle segment, a forward-tilted segment in the upper part and a backward-tilted segment in the lower part, there being diffusion openings for the outflow of air in the three segments, such that the air flowing out through the diffusion openings of the vertical middle segment allows drying the user's body, the air flowing out through the diffusion openings of the tilted upper segment allows drying the user's head, and the air flowing out through the diffusion openings of the lower tilted segment allows drying the user's feet, all this taking place with the user having a normal posture standing in front of the drier apparatus, without having to adopt unnatural postures entailing a risk of falling.

The channel inside the column is envisaged to be wider in the angle between the tilted upper segment and the vertical middle segment of the column than in the rest of the channel, which in turn favors air circulating towards the vertical middle segment without head loss.

Said body drier object of the invention therefore has features making it advantageous for its intended function, being novel and preferred with respect to apparatus that are known for the same application.

### DESCRIPTION OF THE DRAWINGS

FIG. 1 shows an exploded perspective view of an embodiment of the body drier object of the invention.

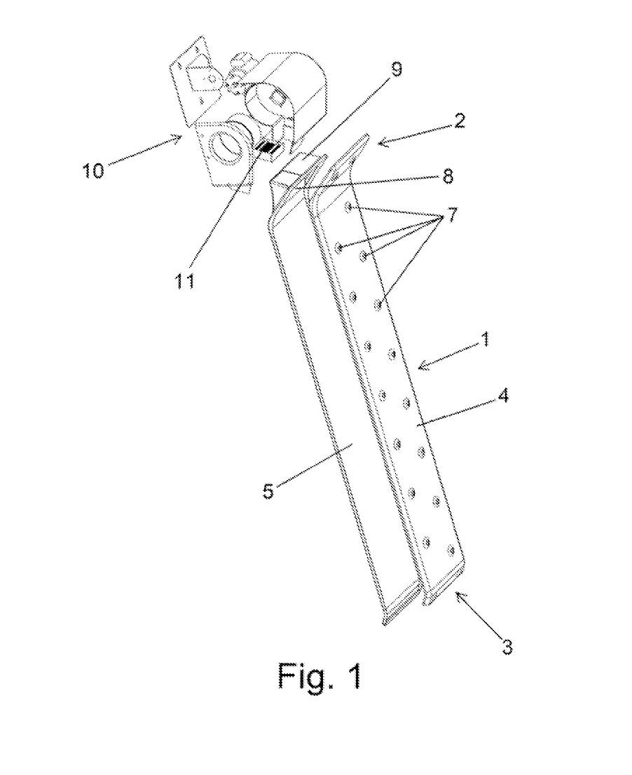

FIG. 2 is a perspective view of the body drier of the preceding figure assembled in this case, seen from the front part.

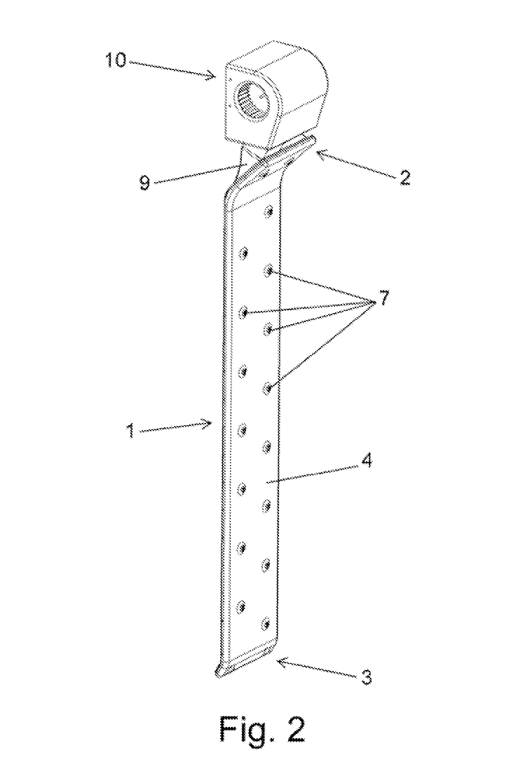

FIG. 3 is a perspective view of the same body drier seen from the back part.

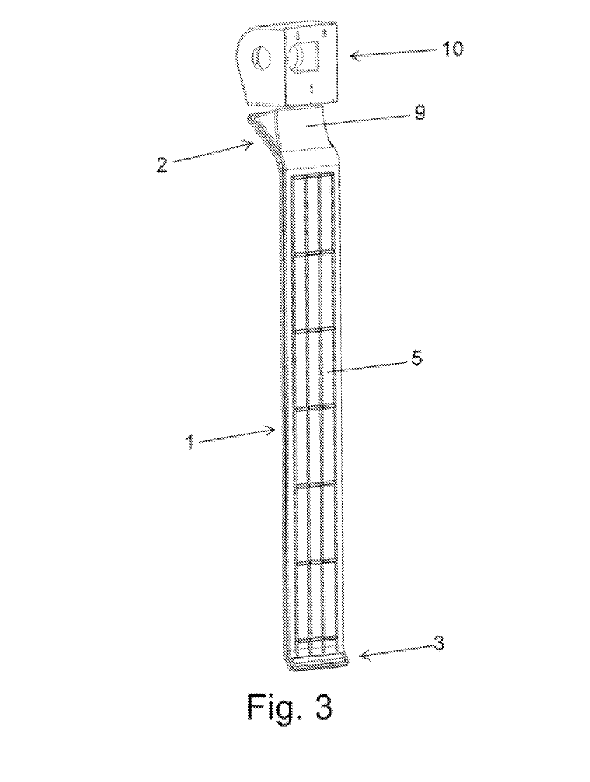

FIG. 4 is a side view of the body drier.

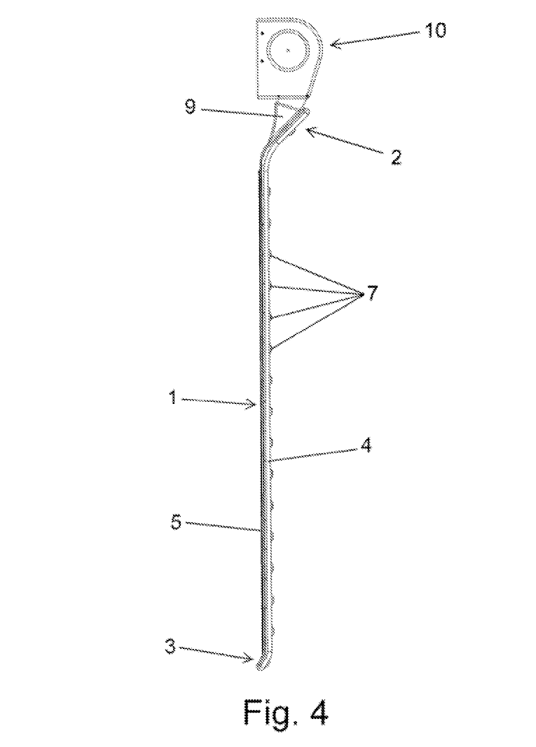

FIG. 5 is a sectioned side view of the body drier.

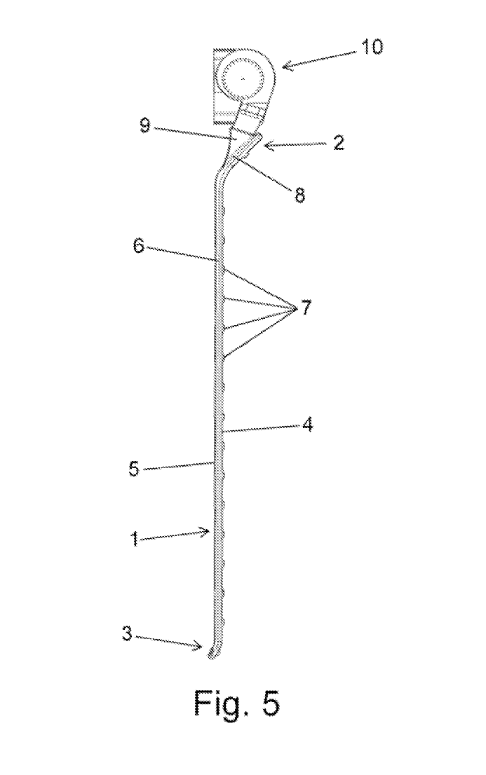

FIG. 6 is an enlarged section detail of an area in which a diffusion opening of the column of the body drier is located.

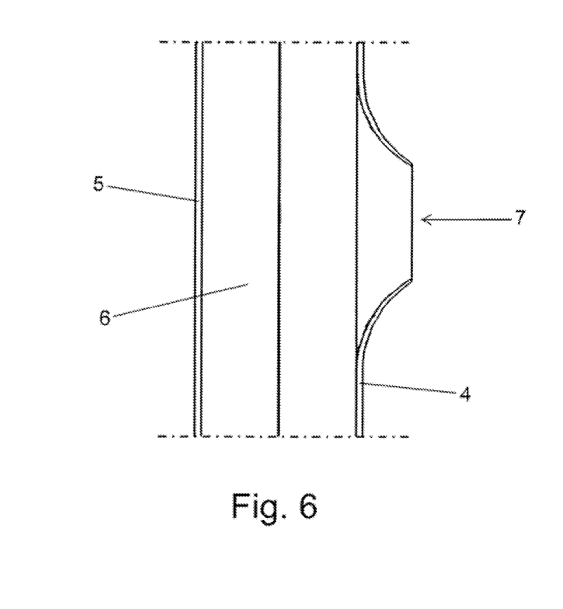

### DETAILED DESCRIPTION OF THE INVENTION

The object of the invention relates to a drier intended for drying a person's body after a shower or bath, based on projecting air that is guided towards the user, through projections oriented towards the body, the head and the feet, such that integral drying of the entire body is obtained without requiring the user to make any effort or adopt uncomfortable postures.

The proposed drier consists of a column that is the height of an average person, said column being envisaged with a longitudinal configuration formed by a vertical middle segment (1), a forward-tilted upper segment (2) and a backward-tilted lower segment (3).

According to a particular embodiment, structurally speaking, the body of the column can be formed by a front plate (4) and a back plate (5), arranged facing one another; however, said body of the column can also be formed by a one-piece element, internally defining in either case a longitudinal channel (6), which is closed along the side edges and at the ends of the column, a distribution of diffusion openings (7) forming outlets for projecting air to the outside being open from said inner channel (6), on the front part of the three segments (1, 2 and 3) of the column.

The column furthermore has an opening (8) on the upper part, in relation to which a mouth element (9) is arranged, to which the air outlet of a fan (10) is coupled, including in said coupling one or more heating resistors (11) the activation of which is selectively controlled in combination with the operation of the fan (10).

An apparatus is thereby obtained in which an airflow is driven through the mouth element (9) towards the inner channel (6) of the column by means of the fan (10), the airflow circulating through said inner channel (6) to flow out by being projected through the diffusion openings (7), such that the air that flows out projected through the diffusion openings (7) of the vertical middle segment (1) can strike the body of a user standing in front of the apparatus, whereas the air that flows out projected through the diffusion openings (7) of the forward-tilted upper segment (2) strikes the head of the user and the air that flows out projected through the diffusion openings (7) of the backward-tilted lower segment (3) strikes the feet of the user; thereby directly achieving integral drying of the entire body of the user by means of the air that is projected out.

The effectiveness of the drying and the functional performance of the apparatus for that function essentially depend on the conditions of the projection of the air through the diffusion openings (7), which conditions, in turn, depend on the drive provided by the fan (10) and on the circulation of the airflow from the outlet of the fan (10) to the outlet for projection through the diffusion openings (7).

In that sense, the mouth element (9) through which the air passes from the fan (10) to the inner channel (6) of the column of the drier apparatus is defined with a ratio between the section of the inlet through which it receives the air from the fan (10) and the section of the outlet through which the air passes into inner channel (6) of the column in a range between 18% and 25%, and particularly 23.6%, whereby achieving conditions for the passage of air which favor taking advantage of the drive of the fan (10).

The inner channel (6) is wider in the angle between the vertical middle segment (1) and the forward-tilted upper segment (2) than the rest of said inner channel (6), whereby achieving circulation of the air through the inner channel (6) virtually without head loss; this is also aided by the fact that the projection of the air driven by the fan (10), in the inlet into the inner channel (6) of the column, through the mouth element (9), is virtually aligned with said inner channel (6) of the column.

In addition, the section of the inner channel (6) for the circulation of air becomes progressively narrower from the upper part to the lower part of the column, which allows compensating for the loss of speed of the air due to the flow rate gradually dropping as a result of the outflow of part of the air through the diffusion openings (7) from the upper part to the lower part.

In order to achieve an outflow of air projected through the diffusion openings (7) such that it is effective for the drying function and with optimal performance of the operation of the fan (10) for driving the air, the ratio between the section for the passage of air from the fan (10) to the mouth element (9) and the section for the outflow of air through the set of diffusion openings (7) is defined in a range between 42% and 50%, said ratio particularly being envisaged to be 47%.

In order to improve the outflow of air that is projected out, the diffusion openings (7) are defined with an outwardly protruding edge, according to a taper with a curved wall with a radius of curvature between 10 millimeters and 20 millimeters, particularly 15 millimeters, and with a ratio between the end aperture section and the base aperture section in a range between 32% and 42%, and particularly 38%, whereby achieving an outflow of air that is projected without head loss and with an increase in speed, favoring performance.

For the purpose of mounting the drier apparatus, the mouth element (9) is envisaged to have an elongated configuration between the part that is coupled with the fan (10) and the part that is coupled with the opening (8) in communication with the inner channel (6) of the column, thereby allowing an installation of the drier apparatus in which the fan (10) can be concealed in a suspended ceiling.

1. A body drier for a shower or bath, formed by a column through the inside of which an airflow is driven so that it flows out towards the user through a distribution of diffusion openings on the front part of the column, wherein it is formed by a column which longitudinally defines on the inside thereof a channel becoming progressively narrower from the upper part to the lower part, which is closed along the side edges and at the ends of the column, having an opening on the upper part in relation to which a mouth element is arranged, to which the outlet of a fan driving the air is coupled, said mouth element having a ratio comprised between 18% and 25%, between the section of the air inlet through which it is coupled to the fan and the section of the air outlet through which it is coupled to the opening in communication with the inner channel of the column.

2. The body drier for a shower or bath according to claim 1, wherein the mouth element particularly has a ratio of 23% between the section of the air inlet through which it is coupled to the fan and the section of the air outlet through which it is coupled to the opening in communication with the inner channel of the column.

3. The body drier for a shower or bath according to claim 1, wherein the column has a longitudinal configuration formed by a vertical middle segment, a forward-tilted upper segment and a backward-tilted lower segment, having diffusion openings on the front part of the three segments for the outflow of air from the inner channel to the outside.

4. The body drier for a shower or bath according to claim 1, wherein the ratio between the section for the passage of air from the fan to the mouth element and the section for the outflow of air through the set of diffusion openings is comprised in a range between 42% and 50%.

5. The body drier for a shower or bath according to claim 4, wherein the ratio between the section for the passage of air from the fan to the mouth element and the section for the outflow of air through the set of diffusion openings is particularly 47%.

6. The body drier for a shower or bath according to claim 1, wherein the inner conduit of the column is wider in the angle between the vertical middle segment and the forward-tilted upper segment than in the rest of said inner channel.

7. The body drier for a shower or bath according to claim 3, wherein the diffusion openings for projecting the outflow of air have an outwardly protruding edge, according to a taper with a curved wall with a radius of curvature between 10 millimeters and 20 millimeters, and particularly 15 millimeters; and with a ratio between the end aperture section and the base aperture section between 32% and 42%, and particularly 38%.
